(19) United States
(12) Patent Application Publication
(10) Pub. No.: US 2023/0401612 A1
(43) Pub. Date: Dec. 14, 2023

(54) VEHICLE MANAGEMENT SYSTEM

(71) Applicant: TOYOTA JIDOSHA KABUSHIKI KAISHA, Toyota-shi Aichi-ken (JP)

(72) Inventors: Yukinari KATO, Okazaki-shi Aichi-ken (JP); Shintaro MATSUTANI, Kariya-shi Aichi-ken (JP); Keiichi UNO, Chita-gun Aichi-ken (JP)

(73) Assignee: TOYOTA JIDOSHA KABUSHIKI KAISHA, Toyota-shi Aichi-ken (JP)

(21) Appl. No.: 18/128,722

(22) Filed: Mar. 30, 2023

(30) Foreign Application Priority Data
Jun. 10, 2022 (JP) 2022-094569

(51) Int. Cl. G06Q 30/0283; G06Q 10/02; B60W 60/00

(52) U.S. Cl. CPC G06Q 30/0283; G06Q 10/02; B60W 60/00253

(57) ABSTRACT

A management server executes a process including: a step of acquiring operation information) when an execution condition is established; a step of setting a traveling route; a step of setting a first usage fee as a fee, when there is a vehicle set on a forwarding route, and when the vehicle on the forwarding route is in a high load state; a step of setting a second usage fee that is higher than the first usage fee as the usage fee when the vehicle on the forwarding route is in a low load state; a step of setting a usage fee for the vehicle on a normal route; and a step of transmitting fee information to the vehicle.

### CROSS-REFERENCE TO RELATED APPLICATION

This application claims priority to Japanese Patent Application No. 2022-094569 filed on Jun. 10, 2022, incorporated herein by reference in its entirety.

### BACKGROUND

### 1. Technical Field

The present disclosure relates to a vehicle management system.

### 2. Description of Related Art

When a vehicle is used to provide transportation services, etc., maintenance such as replacement of consumables and adjustment of vehicle parts is performed periodically. However, the vehicle cannot be used to provide services during the maintenance period. Thus, the opportunity to provide services may be lost. Therefore, it is desired that vehicle maintenance be performed at an appropriate timing in accordance with a demand state of service provision or in consideration of the service provision status using multiple vehicles in the case where services are provided using multiple vehicles.

Japanese Unexamined Patent Application Publication No. 2020-013373 (JP 2020-013373 A) discloses a vehicle maintenance management system that gives an instruction for maintenance to be performed by using vehicle usage information.

### SUMMARY

In the vehicle used for providing the above services, when the vehicle is continuously used under a high load, the period until the next maintenance is shortened, and the maintenance cost may increase. Therefore, in the case where the usage fees for services using the vehicles are set to a uniform fee system, when the usage fees are set high in order to recover the increased maintenance costs, the widespread of use of the services may be hindered. On the other hand, when the usage fee is set low, the quality of the service may not be maintained due to deterioration in profitability as a result of an increase in maintenance costs even when the use of the service becomes widespread.

The present disclosure has been made to solve the above-described problems, and its object is to provide a vehicle management system that promotes the use of services and maintains the quality of services.

A vehicle management system according to an aspect of the present disclosure includes a vehicle used for providing a transportation service and a server that is able to communicate with the vehicle. When the server receives request information including a request to provide a transportation service using the vehicle along a predetermined traveling route, the management server uses the request information to obtain a load degree that indicates the degree of load acting on the vehicle when the vehicle travel along the traveling route. The server sets the usage fee so that when the calculated load degree is high, the usage fee for providing transportation services on the predetermined traveling route is lower than when the load degree is low.

In this way, when a transportation service is provided on a predetermined traveling route using a vehicle with a high load degree, the usage fee will be lower than a vehicle with a low load degree. As a result, it is possible to increase a usage frequency of a transportation service using a vehicle that has a high load degree on a predetermined traveling route. Therefore, use of the service can become widespread. Furthermore, by relatively reducing the usage frequency of the vehicle in the low load degree, it is possible to suppress the period until the next maintenance from being shortened and thus, the quality of service can be maintained. Therefore, it is possible to spread the use of the service and maintain the quality of the service.

In one embodiment, the predetermined traveling route includes a location at which vehicle maintenance is performed.

In this way, when a transportation service is provided using a vehicle with a high load degree on a predetermined traveling route including a place at which maintenance of the vehicle is performed, the usage fee will be lower than a vehicle with a low load degree. As a result, it is possible to increase a usage frequency of a transportation service using a vehicle that has a high load degree on a predetermined traveling route.

Further, in one embodiment, the request information includes information on at least one of a traveling distance of the vehicle, the number of passengers, and a part that is a maintenance target.

In this way, the load degree of the vehicle can be calculated with high accuracy by using information on at least one of the traveling distance of the vehicle, the number of passengers, and the part that is the maintenance target.

Further, in some embodiments, the vehicle includes an autonomous driving vehicle.

In this way, it is possible to increase a usage frequency of a transportation service by autonomous driving using a vehicle that has a high load degree on a predetermined traveling route.

According to the present disclosure, it is possible to provide a vehicle management system that promotes the use of services and maintains the quality of services.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a vehicle management system;

FIG. 2 is a diagram showing an example of a configuration of an autonomous driving kit (ADK) and a vehicle platform (VP) in more detail;

FIG. 3 is a flowchart showing an example of a process executed by a management server; and

FIG. 4 is a diagram for describing a normal traveling route and a forwarding route.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

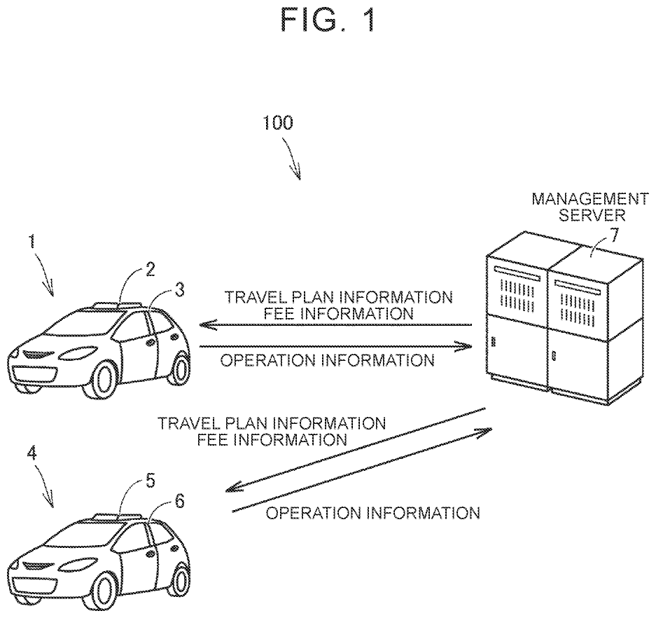

FIG. 1 is a diagram schematically showing an overall configuration of a vehicle management system 100. The vehicle management system 100 manages a plurality of vehicles. In practice, many vehicles can be managed by the vehicle management system 100, but for convenience of explanation, a case where specific vehicles 1 and 4 are managed by the vehicle management system 100 will be described below as an example. The vehicle management system 100 includes the vehicles 1 and 4 and a management server 7. The vehicle 1 includes an autonomous driving kit (ADK) 2 and a vehicle platform (VP) 3. Similarly, the vehicle 4 includes an ADK 5 and a VP 6.

The users of the vehicles 1 and 4 may be, for example, businesses that provide transportation services by autonomous driving by using the vehicles 1 and 4 (bus businesses, taxi businesses, rental car businesses, car sharing businesses, or ride sharing services business operators, etc.). In the present embodiment, it is assumed that users of the vehicles 1 and 4 are, for example, business operators who own a plurality of vehicles and provide personnel transportation services. A transportation service for people is, for example, driving a vehicle along multiple traveling routes (such as traveling route that passes through an urban area and a traveling route that passes through a mountainous area), and having people load and alight at a predetermined boarding/alighting point provided on the traveling routes while moving so as to arrive at the predetermined boarding/alighting point set on the traveling route at a predetermined set time, and charging a usage fee. In the present embodiment, for convenience of explanation, the plurality of traveling routes is set to include the forwarding route including the location of the maintenance facility and the normal route that circulates through a plurality of predetermined boarding/alighting points without going through the maintenance facility.

An example of a configuration for autonomous driving will be described below, with the vehicle 1 serving as an example. The ADK 2 mounted on the vehicle 1 is configured to be attachable to the VP 3 of the vehicle 1 and detachable from the VP 3. The ADK 2 is attached to a predetermined position such as the rooftop of VP 3, for example. The ADK 2 is configured to enable autonomous driving of the vehicle 1.

Specifically, the ADK 2 creates a travel plan for the vehicle 1. The ADK 2 outputs various control requests for causing the vehicle 1 to travel in accordance with the travel plan to the VP 3, following an application program interface (API) defined for each control request. The ADK 2 also receives various signals indicating the vehicle state (state of VP 3) from the VP 3 in accordance with an API defined for each signal. The ADK 2 then reflects the vehicle state on the travel plan. The ADK 2 may create a travel plan using the travel plan information from the management server 7, for example.

The VP 3 executes traveling control in the autonomous driving mode according to the control request from ADK 2. When the ADK 2 is removed from the VP 3, the VP 3 is configured to be able to execute a traveling control in manual mode (a traveling control according to the driver's operation).

The VP 3 transmits various types of information (operation information and the like, which will be described later) to the management server 7 in the vehicle management system 100.

The management server 7 may be a company's own server, a shared server shared by a plurality of companies including the above company, or a cloud server provided by a cloud server management company.

The management server 7 is, for example, a server operated by an operator who maintains and manages a plurality of vehicles including the vehicle 1. The business operator may be, for example, the VP 3 manufacturer or the ADK 2 manufacturer. Furthermore, the management server 7 may be configured to include a server operated by the manufacturer of VP 3 and the server operating ADK 2. In the following description, an example in which the management server 7 is configured of one server will be described.

The management server 7 is configured to be able to receive operation information from each of the vehicles 1 and 4. The operation information of the vehicles 1 and 4 includes information that can identify the vehicles 1 and 4 such as license plate numbers and manufacturing numbers (hereinafter referred to as a vehicle ID), information on a driving history (hereinafter referred to as history information), and information on maintenance of the vehicles 1 and 4 (hereinafter referred to as maintenance information). The management server 7 includes a database (not shown) for storing operation information received from at least one of the vehicles 1 and 4 in a format that allows identification of the vehicle that sent the information. The management server 7 generates the travel plan information and fee information by using the received operation information, and transmits them to the vehicles 1 and 4.

In the present disclosure, “maintenance” of a vehicle means all actions for maintaining the vehicle in a normal state and restoring the vehicle from an abnormal state to a normal state. Maintenance may include inspection, repair, adjustment, or replacement of any part provided on the vehicle. The maintenance information may include, for example, information for diagnosing whether maintenance is required, such as a mileage after maintenance of a part that is the maintenance target, a mileage until a next maintenance of the part, and the like, and may include information indicating a diagnosis result as to whether maintenance is required.

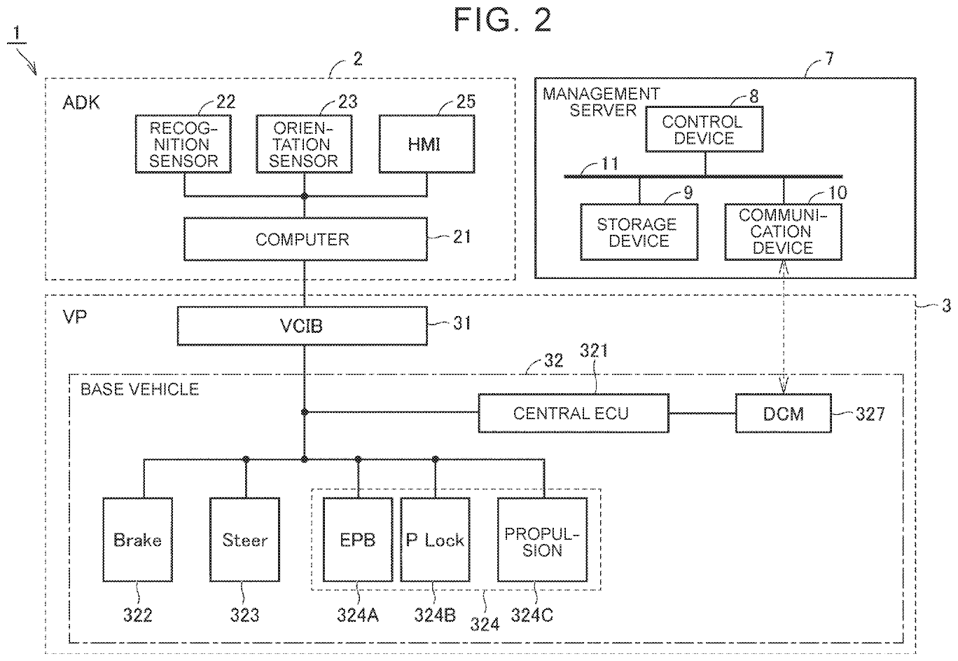

FIG. 2 is a diagram showing an example of a configuration of the ADK 2 and the VP 3 in more detail. The ADK 2 includes a computer 21, a recognition sensor 22, an orientation sensor 23, and a human machine interface (HMI) 25.

The VP 3 includes a vehicle control interface box (VCIB) 31 and a base vehicle 32. The base vehicle 32 includes a central electronic control unit (ECU) 321, a braking system 322, a steering system 323, a powertrain system 324, and a digital communication system (DCM) 327.

The powertrain system 324 includes an electric parking brake (EPB) system 324A, a parking lock (P-lock) system 324B, and a propulsion system 324C.

The computer 21 acquires data regarding the environment of the vehicle 1 by using the recognition sensor 22 during autonomous driving of the vehicle 1. In addition, the computer 21 acquires data on the orientation, behavior and position of the vehicle 1 by using orientation sensor 23 during autonomous driving of the vehicle 1. Furthermore, the computer 21 is communicably connected to the VCIB 31. The computer 21 acquires the vehicle state from the VP 3 via the VCIB 31 and sets the next operation (acceleration, deceleration, turning, etc.) of the vehicle 1. The computer 21 outputs various commands to the VP 3 via the VCIB 31 to implement the following operations.

The recognition sensor 22 is a sensor for recognizing the environment of the vehicle 1. The recognition sensor 22 includes, for example, at least one of a laser imaging detection and ranging (LIDAR), a millimeter wave radar, and a camera (all not shown). The LIDAR emits, for example, infrared pulsed laser light and measures the distance and the direction of an object by detecting the reflected light of the laser light from the object. The millimeter wave radar measures the distance and the direction of an object by emitting millimeter waves and detecting the reflected waves of the millimeter waves from the object.

The camera captures an image ahead of the vehicle 1.

The orientation sensor 23 is a sensor for detecting the orientation, behavior, and position of the vehicle 1. The orientation sensor 23 includes, for example, an inertial measurement unit (IMU) and a position detection device such as a global positioning system (GPS) (both not shown). The IMU detects, for example, the longitudinal, lateral, and vertical accelerations of the vehicle 1 and the angular velocities of the vehicle 1 in the roll, pitch, and yaw directions. The GPS locates the vehicle 1 using information received from multiple GPS satellites orbiting the earth.

The HMI 25 is configured to be connected to an input/output device (not shown) such as a touch panel display provided on the base vehicle 32, for example.

The VCIB 31 is communicably connected to the ADK 2 through controller area network (CAN) or the like. The VCIB 31 receives various control requests from the ADK 2 and outputs the vehicle state to the ADK 2 by executing a predetermined API defined for each signal. Upon receiving a control request from the ADK 2, the VCIB 31 outputs a control command corresponding to the control request to a system (for example, a braking system 322, a steering system 323, and a powertrain system 324) corresponding to the control command. Also, the VCIB 31 acquires various types of information about the vehicle state (the state of the base vehicle 32) and outputs the acquired information to the ADK 2.

The central ECU 321 transmits various information indicating the vehicle state to the management server 7 and various requests to the management server 7, via the DCM 327. The central ECU 321 also receives commands or notifications from the management server 7 via the DCM 327. Further, the central ECU 321 uses the vehicle state acquired from each system of the VP 3 to diagnose whether maintenance is required in the VP 3, or receives the diagnosis result of the self-diagnosis performed in each system of the VP 3 to use the received diagnosis result so as to diagnose whether the state is such that maintenance is required in the VP 3.

In the present embodiment, the central ECU 321 will be described as an executing entity of diagnostic processing for diagnosing whether maintenance of the vehicle 1 is required. However, in addition to the above function, the central ECU 321 may have a function (gateway function) such as relaying communication between ECUs included in each system.

The braking system 322 is configured to control braking devices (not shown) provided on each wheel of the base vehicle 32. The steering system 323 is configured to control a steering angle of steered wheels of the vehicle 1 using a steering device (not shown).

The EPB system 324A controls an EPB (not shown) provided on at least one of the wheels following a control request transmitted from the ADK 2 via the VCIB 31. The P-lock system 324B controls a P-lock device (not shown) provided in the transmission following a control request transmitted from the ADK 2 through the VCIB 31. The propulsion system 324C controls a driving force from a drive source (such as a motor generator and an engine, which are not shown) following the control request/requirement from the ADK 2.

The DCM 327 is an in-vehicle communication module. The DCM 327 is configured to enable two-way data communication between the central ECU 321 and the management server 7.

The ADK 5 of the vehicle 4 has the same configuration as the ADK 2 of the vehicle 1. Furthermore, the VP 6 of the vehicle 4 has the same configuration as the VP 3 of the vehicle 1. Therefore, detailed descriptions thereof will not be repeated.

The management server 7 includes a control device 8, a storage device 9 and a communication device 10. The control device 8, the storage device 9 and the communication device 10 are communicably connected to each other via a communication bus 11.

The control device 8 includes a central processing unit (CPU), a memory (read only memory (ROM), a random access memory (RAM), etc.), input/output ports for inputting and outputting various signals, etc., although none of them are shown. Various controls that are executed by the control device 8 are executed by software processing, that is, programs stored in the memory are read out by the CPU. The various controls by the control device 8 can also be realized by a general-purpose computer (not shown) executing a program stored in a storage medium. The various controls by the control device 8 are not limited to software processing, and may be processed by dedicated hardware (electronic circuits).

The storage device 9 stores operation information received from the vehicles 1 and 4 configured to be able to communicate with the management server 7.

The communication device 10 realizes two-way communication between the vehicles 1 and 4 and a communication network (not shown). The management server 7 enables a plurality of vehicles including the vehicles 1 and 4 to communicate with each other via a base station (not shown) provided in a communication network by using the communication device 10.

In the vehicle management system 100 having the configuration described above, for example, the management server 7 sets a traveling route indicating route information on which each of the vehicles 1 and 4 travels, and transmits travel plan information to each of the vehicles 1 and 4 so as to arrive at or depart from boarding/alighting points on the set traveling route at preset times. Furthermore, the management server 7 transmits to the vehicles 1 and 4, information about the usage fee of the vehicle on the set traveling route as fee information.

In each of the vehicles 1 and 4, autonomous driving is carried out following the travel plan information, fee information is presented to the user by using a display device or the like, and settlement processing is executed in accordance with the time of use by the user. In this way, in each of the vehicles 1 and 4, the user gets on and off at the boarding/alighting points, and the transportation service for the personnel moving on the traveling route is provided.

When a plurality of vehicles, including the vehicles 1 and 4, are used to provide personnel transportation services, maintenance of the vehicles 1 and 4 is performed on a regular basis.

For example, whether maintenance of the vehicles 1 and 4 is necessary is determined by diagnosing whether each of the vehicles 1 and 4 is in a state requiring maintenance in the vehicles 1 and 4 or management server 7.

Cases of diagnosing whether the vehicle 1 is in a state requiring maintenance include: when a usage period of a diagnostic target part exceeds a threshold from the time of the last replacement, when an amount of consumption of the diagnostic target part since the last replacement exceeds a threshold, when an error code of the diagnostic target part is output, or when an output value of the diagnostic target part becomes abnormal.

For example, when the usage period of various oils used in the engine, the motor generator, etc. from the time of the previous replacement exceeds a threshold set in accordance with the type of oil, the diagnosis is that maintenance for oil replacement is required. Alternatively, when an amount of wear of the brake pads included in the braking device exceeds a threshold value, it is diagnosed that maintenance for replacement of the brake pads is required. Alternatively, when a predetermined error code is output from equipment related to the driving operation of the vehicle 1, such as the engine and the motor generator, it is diagnosed that inspection and maintenance are required. Alternatively, when output values of various sensors exceed a normal range, it is diagnosed that maintenance such as sensor replacement or adjustment is required.

These determinations are made using the diagnostic results of self-diagnostic processing executed in the vehicle 1. The self-diagnostic process is executed, for example, by the computer 21 of the ADK 2 or the central ECU 321 of the VP 3. Alternatively, the management server 7 may manage information about the maintenance history of the vehicles 1 and 4, execute diagnostic processing by using the managed information, and use the diagnostic result to determine whether maintenance is required.

However, when it is diagnosed that maintenance is required as described above and maintenance is carried out, the vehicles 1 and 4 cannot be used to provide the service during the period of maintenance. Thus, the opportunity to provide the service is lost. Therefore, it is required to perform vehicle maintenance at an appropriate timing in consideration of the service provision demand and the service provision status.

When the vehicles 1 and 4 as described above are used continuously under a high load condition, the period until the next maintenance is shortened, and the maintenance cost may increase. Therefore, in the case where the usage fees for services using the vehicles 1 and 4 are set to a uniform fee system, when the usage fees are set high in order to recover the increased maintenance costs, the widespread of use of the services may be hindered. On the other hand, when the usage fee is set low, the quality of the service may not be maintained due to deterioration in profitability as a result of an increase in maintenance costs even when the use of the service becomes widespread.

Therefore, in the present embodiment, it is assumed that the management server 7 operates as follows. That is, when the management server 7 acquires request information including a request to provide a transportation service using the vehicles 1 and 4 along a predetermined traveling route, the management server 7 uses the request information to obtain a load degree that indicates the degree of load acting on the vehicle when the vehicles 1 and 4 travel along the traveling route. The management server 7 sets the usage fee so that when the calculated load degree is high, the usage fee for providing transportation services on the predetermined traveling route is lower than when the load degree is low.

More specifically, in the present embodiment, when the management server 7 acquires information (request information) for setting a traveling route for providing a transport service in either the vehicle 1 or 4 as a forwarding route, the information is used to calculate the load degree of the vehicle when traveling the forwarding route. The forwarding route is a predetermined traveling route including the location of the maintenance facility. The management server 7 calculates whether the vehicle that is the maintenance target is in a high load state or a low load state when traveling on the forwarding route, as a two-stage load degree. When it is determined that the load is high, the management server 7 sets the usage fee so that the usage fee for providing the transport service on the forwarding route is lower than in the low load state.

In this way, it is possible to increase the usage frequency of transportation services using vehicles in a high load state before maintenance on the forwarding route. Therefore, use of the service can become widespread. Furthermore, by relatively reducing the usage frequency of the vehicle in the low load state, it is possible to suppress the period until the next maintenance from being shortened and thus, the quality of service can be maintained. Therefore, it is possible to spread the use of the service and maintain the quality of the service.

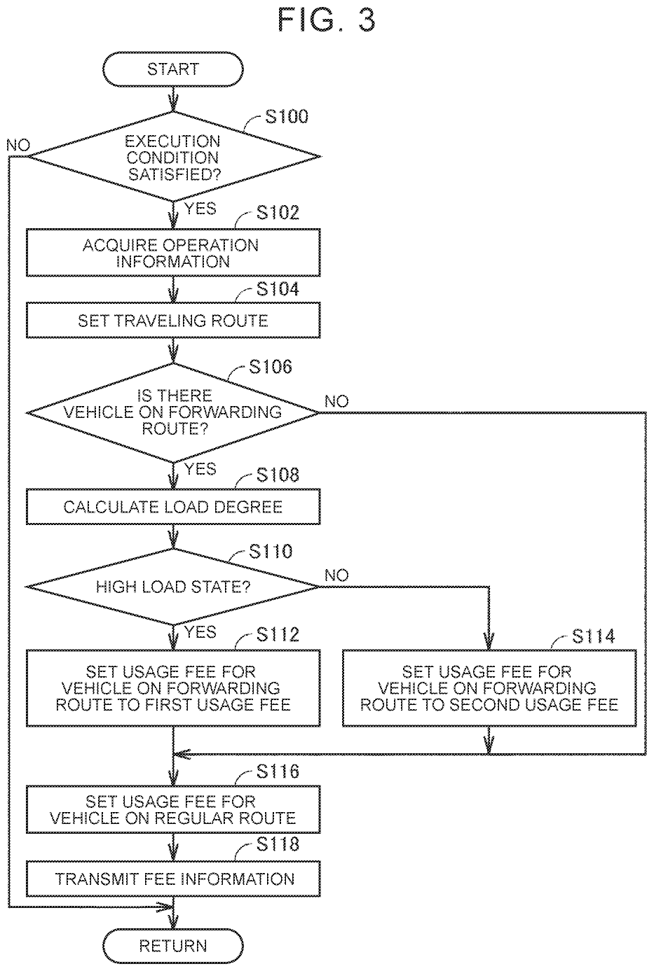

An example of processing executed in the management server 7 will be described below with reference to FIG. 3. FIG. 3 is a flowchart showing an example of a process executed by the management server 7. A series of processes shown in this flowchart are repeatedly executed by the management server 7 at predetermined intervals.

At step (hereinafter, a step is referred to as S) 100, the management server 7 (more specifically, the control device 8 of the management server 7) determines whether an execution condition for executing the process of setting the usage fee is satisfied. The execution condition may include, for example, a condition that a predetermined period of time has elapsed since a previous usage fee was set, or a condition that it is a time zone other than a time zone in which the service is provided, or a condition that a predetermined time has passed from the time when the previous traveling route was set. When it is determined that the execution condition is satisfied (YES at S100), the process proceeds to S102.

In S102, the management server 7 acquires the operation information. The management server 7 acquires the operation information from each of a plurality of vehicles including the vehicles 1 and 4. For example, when the management server 7 requests the operation information from the vehicle 1 via the communication device 10, the central ECU 321 of the vehicle 1 receives the request signal from the management server 7 via the DCM 327. The central ECU 321 acquires the operation information from the computer 21 of the ADK 2 or the memory of the central ECU 321, for example, and transmits the acquired operation information to the management server 7 via the DCM 327.

At S104, the management server 7 sets the traveling route for each of the plurality of vehicles. For example, when the operation information of any one of the plurality of vehicles includes information indicating that maintenance is required, the management server 7 sets the traveling route of the vehicle as the forwarding route. The management server 7 sets the traveling route other than the vehicle set as the forwarding route to the normal traveling route. The management server 7 sets, for example, departure/arrival times and the like at the boarding/alighting point on the vehicle traveling route set for each of the normal traveling route and the forwarding route. The management server 7 transmits the set information as the travel plan information to each of the plurality of vehicles. The management server 7 sets a flag associated with the vehicle for which the forwarding route is set to an ON state, and stores the set flag in the storage device 9 in association with the vehicle ID.

In S106, the management server 7 determines whether there is a vehicle for which the forwarding route is set among the plurality of vehicles. The management server 7 determines that there is a vehicle for which the forwarding route is set when there is a vehicle for which the flag is set to the ON state among the plurality of vehicles. When it is determined that there is a vehicle with the forwarding route set (YES at S106), the process proceeds to S108.

At S108, the management server 7 calculates the load degree of each vehicle for which the forwarding route is set. In the present embodiment, for example, a load degree set in two stages, a high load state and a low load state, will be described as an example. For example, the management server 7 may determine that the state is the high load state when a part that is the maintenance target is a predetermined part (for example, a drive system part such as an engine or a motor generator). Alternatively, when the moving distance from the current location of the vehicle for which the forwarding route is set to the location of the maintenance facility via the forwarding route is greater than or equal to the predetermined travel distance, the management server 7 may determine that the vehicle is in the high load state, and when the estimated number of passengers during travel to the maintenance facility via the forwarding route exceeds a threshold, the management server 7 may determine that the state is the high load state. The management server 7 may calculate the moving distance to the location of the maintenance facility by using, for example, map information including the maintenance facility. The management server 7 may calculate, for example, a predicted value of the number of passengers on the forwarding route to the location of the maintenance facility by using past results, or may calculate the status of reservations for vehicles set on the forwarding route (number of reservations) to calculate the predicted number of passengers on the forwarding route. These load degree calculation methods are examples, and are not limited to the calculation methods described above. After that, the process moves to S110.

At S110, the management server 7 determines whether the vehicle set for the forwarding route is in a high load state. When it is determined that the load is high, the process proceeds to S112.

In S112, the management server 7 sets the usage fee for the vehicle on the forwarding route to the first usage fee. The first usage fee may include, for example, a uniform usage fee for moving to the location of the maintenance facility, may include a usage fee per predetermined distance, or may include a usage fee per a predetermined time. After that, the process moves to S116. When it is determined that the state is not the high load state set to the forwarding route (NO in S110), the process proceeds to S114.

In S114, the management server 7 sets the usage fee for the vehicle on the forwarding route to the second usage fee. The second usage fee is set higher than the first usage fee (that is, the first usage fee is set lower than the second usage fee). After that, the process moves to S116.

At S116, the management server 7 sets the usage fee for the vehicle traveling on the normal traveling route. After that, the process moves to S118.

At S118, the management server 7 generates fee information by using the set usage fee, and transmits the generated fee information to each of the plurality of vehicles. The management server 7, for example, transmits the fee information to the vehicle 1 via the communication device 10. When the central ECU 321 of the vehicle 1 receives the fee information via the DCM 327, it may notify the passenger by using the received fee information, for example. The central ECU 321 may display the fee on a display device installed in the vehicle 1, for example. For example, when there is an occupant in the vehicle cabin of the vehicle 1, the central ECU 321 may notify the occupant by outputting voice information indicating guidance of the fee by using a display device or a voice generator.

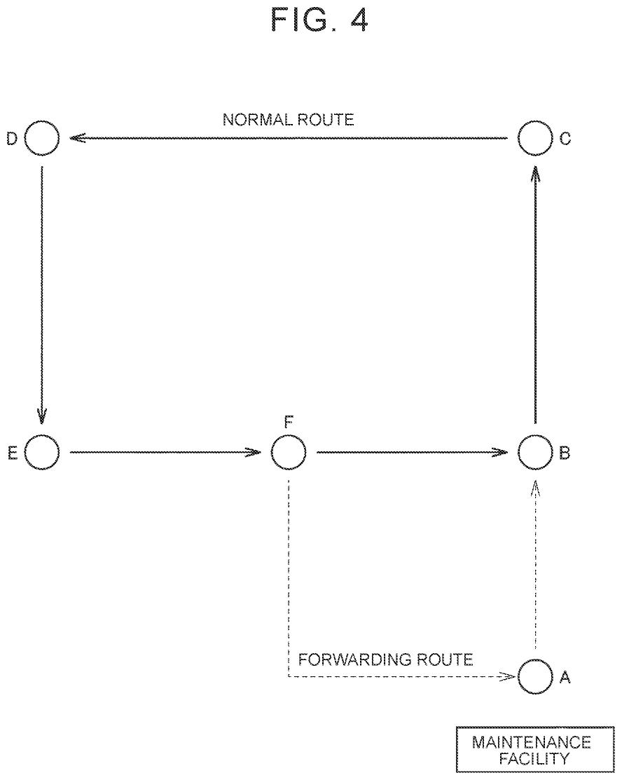

An example of the operation of the management server 7 based on the above structure and flowchart will be described with reference to FIG. 4.

FIG. 4 is a diagram for describing the normal traveling route and the forwarding route. As shown in FIG. 4, the forwarding route includes the location of the maintenance facility. (A) to (F) of FIG. 4 show boarding/alighting points.

For example, it is assumed that the vehicle 1 of the plurality of vehicles is determined to be in a state requiring maintenance by the self-diagnostic processing.

At this time, in the management server 7, it is determined that the execution condition is established when a predetermined time has elapsed since the previous setting of the traveling route (YES in S100).

Thus, the operation information is acquired from each of the plurality of vehicles (S102). The traveling route is set by using the acquired operation information (S104). At this time, in the vehicle 1, the forwarding route is set as the traveling route, and the corresponding flag is set to the ON state.

Since the flag corresponding to the vehicle 1 of the plurality of vehicles is set to the ON state, it is determined that there is a vehicle on the forwarding route (YES at S106). Therefore, the load degree of the vehicle 1 on the forwarding route is calculated (S108), and when the vehicle 1 on the forwarding route is in the high load state (YES in S110), the first fee is set as the usage fee for the vehicle 1 on the forwarding route (S112). Then, a usage fee is set for the vehicle for which a traveling route other than the forwarding route is set (S116), and the fee information is transmitted to each of the plurality of vehicles (S118).

As shown in FIG. 4, the vehicle for which a traveling route other than the forwarding route (normal route) is set moves between each boarding/alighting point in the order of (B), (C), (D), (E), and (F) in FIG. 4 and returns to (B), and circulates. That is, the normal route is a route that circulates through (B) to (F) in FIG. 4.

On the other hand, the vehicle for which the forwarding route is set moves from the boarding/alighting point of (F) in FIG. 4 to the boarding/alighting point set at (A) of the maintenance facility. That is, the forwarding route is a route with (A) in FIG. 4 serving as an end point. The forwarding route includes at least the moving route from (F) to (A) in FIG. 4. Any one of (B) to (F) in FIG. 4 may be used as the starting point of the forwarding route. The usage fee for the transport service provided when the vehicle 1 moves up to (A) in FIG. 4 is set to be a lower fee than in a case of a low load state. After maintenance of the vehicle 1 has been performed at the maintenance facility, it travels from (A) to (B) in FIG. 4 and then travels on the normal route.

As described above, according to the vehicle management system according to the present embodiment, it is possible to increase the usage frequency of the transportation service using the vehicle in the high load state before maintenance on the forwarding route. Therefore, use of the service can become widespread. Furthermore, by relatively reducing the usage frequency of the vehicle in the low load state, it is possible to suppress the period until the next maintenance from being shortened and thus, the quality of service can be maintained. Therefore, it is possible to spread the use of the service and maintain the quality of the service. Therefore, it is possible to provide a vehicle management system that promotes the use of services and maintains the quality of services.

Further, the management server 7 calculates the load degree by using the request information including information of at least one of the traveling distance of the vehicle, the number of passengers, and the part that is the maintenance target and thus, the load degree can be calculate with high accuracy.

Hereinafter, modifications will be described.

In the above-described embodiment, an example is described in which the management server 7 sets the usage fee to be a lower fee than when the vehicle is in the low load state, when the vehicle set to the forwarding route including the location of the repair shop as the end point is in a high load state on the forwarding route. However, it is sufficient if the route includes at least the location of the maintenance facility and the route is not particularly limited to the route ending at the location of the maintenance facility.

Furthermore, in the above-described embodiment, an example is described in which the management server 7 sets the usage fee to a lower amount than when the state is the low load state, when the vehicle set on the forwarding route is in the high load state on the forwarding route. However, when the state is the high load state, a predetermined traveling route different from the forwarding route described above may be set as the traveling route for which the usage fee is set lower in the high load state than in the low load state. For example, the predetermined traveling route may include, for example, a traveling route in which the end point is the boarding/alighting point nearest to the location of the maintenance facility on the normal route.

Furthermore, in the above-described embodiment, the position detection device of the vehicle 1 is provided in the ADK 2 as an example. However, the position detection device may be provided in the VP 3.

Furthermore, in the above-described embodiment, the case of determining whether the vehicle is in a high load state by using the predicted value of the number of passengers has been described as an example. However, an image inside the vehicle may be acquired by using photographing equipment such as a camera provided in the vehicle, the acquired image may be transmitted to the management server 7 in response to a request from the management server 7, and the number of passengers may be acquired from the image in the management server 7.

Furthermore, in the above-described embodiment, described as an example is a case in which the load degree has two stages, a high load state and a low load state. However, it may be divided into three stages or more, or may be quantified by using the movement distance and the part that is the maintenance target. In this case, the management server 7 may determine that the load degree is high when the load degree is equal to or greater than a threshold.

In addition, the above-mentioned modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A vehicle management system comprising:
a vehicle that is used to provide a transportation service; and
a server that is able to communicate with the vehicle,
wherein the server
calculates a load degree indicating a degree of a load that acts on the vehicle when the vehicle travels on a predetermined traveling route by using a request information, when the request information including a request for provision of the transportation service using the vehicle on the predetermined traveling route is acquired, and
sets a usage fee such that when the calculated load degree is high, the usage fee for providing the transportation service on the predetermined traveling route is lower than when the load degree is low.

2. The vehicle management system according to claim 1, wherein the predetermined traveling route includes a location where maintenance of the vehicle is performed.

3. The vehicle management system according to claim 1, wherein the request information includes information on at least one of a traveling distance of the vehicle, a number of passengers, and a part that is a maintenance target.

4. The vehicle management system according to claim 1, wherein the vehicle includes an autonomous driving vehicle.
